(19) United States
(12) Patent Application Publication
(10) Pub. No.: US 2012/0237779 A1
(43) Pub. Date: Sep. 20, 2012

(54) GLASS ROLL AND MANUFACTURING METHOD FOR GLASS ROLL

(76) Inventors: Yasuo TERANISHI, Otsu-shi (JP); Koichi Mori, Otsu-shi (JP); Hiroki Mori, Otsu-shi (JP); Yasuo Yamazaki, Otsu-shi (JP)

(21) Appl. No.: 13/419,575

(22) Filed: Mar. 14, 2012

(30) Foreign Application Priority Data
Mar. 14, 2011 (JP) 2011-055532

(51) Int. Cl. B32B 1/00; C03B 23/023; B32B 17/06

(52) U.S. Cl. 428/426; 65/106

(57) ABSTRACT

Provided is a glass roll (1) formed by rolling a glass film (2) around a roll core (4) under a state in which a resin film (3) is superposed on an outer peripheral surface side of the glass film (2). The resin film (3) is superposed on the outer peripheral surface side of the glass film (2) under a state in which tension of from 100 kPa to 1 GPa is applied to the resin film (3). The following relationships hold true: {(tg×Eg)/(tp×Ep)}×(tg/R)≦0.1, and 1×10⁻⁵≦tg/R≦1×10⁻³, where tg [m] represents a thickness of the glass film (2), Eg [Pa] represents a tensile modulus of elasticity of the glass film (2), tp [m] represents a thickness of the resin film (3), Ep [Pa] represents a tensile modulus of elasticity of the resin film (3), and R [m] represents an outer diameter of the roll core (4).

### TECHNICAL FIELD

The present invention relates to an improved technology for a glass roll formed by rolling a glass film into a roll.

### BACKGROUND ART

As is well known, flat panel displays (FPDs) have become mainstream as image display devices in recent years, the FPDs being typified by a liquid crystal display, a plasma display, an organic light-emitting diode (OLED) display, and the like. As substrates for those FPDs, glass substrates are used in order to secure various demanded properties such as airtightness, flatness, heat resistance, translucency, and insulation property. Further, in view of reducing a weight, the glass substrates to be used for the FPDs are currently becoming thinner. In particular, in the FPDs such as an OLED display may be used under a state in which a display screen is bent, and hence thinning of the glass substrates has been expected for the purpose of imparting flexibility to the glass substrates.

Further, there is a growing use of an OLED as a plane light source, such as a light source for interior illumination, which emits only monochrome (for example, white) light, unlike a display that uses TFTs to blink light of three fine primary colors. Further, when an OLED illumination device includes a glass substrate having flexibility, a light-emitting surface is freely deformable, which leads to an advantage in that the OLED illumination device is usable for a significantly wider range of applications. Therefore, from the viewpoint of ensuring sufficient flexibility, there is also promoted further thinning of the glass substrate to be used for the illumination device of this type.

In response to the above-mentioned demands for thinning, a glass film thinned into a film shape (for example, having a thickness of 300 μm or less) has been developed. The glass film has appropriate flexibility, and hence is sometimes stored in a state of a glass roll that is formed by rolling the glass film into a roll around a roll core (for example, see Patent Literature 1). This reduces a storage space for the glass film, and hence it is possible to increase transportation efficiency. Further, with use of a roll-to-roll apparatus, various processes such as cutting and film formation can be sequentially performed on a glass film that is unrolled from a glass roll situated on an upstream side, and hence it is possible to remarkably increase production efficiency.

### CITATION LIST

Patent Literature 1: JP 2010-132350 A

### SUMMARY OF INVENTION

### Technical Problems

By the way, the glass film has an advantage of being highly flexible, but also has a disadvantage of being likely to break. Accordingly, when rolling the glass film into a roll, in order to prevent breakage of the glass film caused by contact between the rolled parts of the glass film, in general, a resin film as a protective film is superposed on the glass film, and then the resin film and the glass film are rolled around the roll core together.

However, the glass film has a certain level of flexibility, but has a relatively larger modulus of elasticity when compared to that of the resin film. Accordingly, as illustrated in FIG. 4A, there may arise such a phenomenon that an edge portion of a glass film 2 on a′rolling start side is not aligned with an outer peripheral surface of a roll core 4, but separates from the roll core 4 under a state in which the edge portion pushes up a resin film 3 radially outward. Further, as illustrated in FIG. 4B, when the edge portion of the glass film 2 remains separated, at a stage at which the glass film 2 is rolled around the roll core 4 by an amount corresponding to about one cycle, at a position indicated by an arrow X of FIG. 4B, the edge portion of the glass film 2 pushes up and radially outward a subsequent part of the glass film 2, which is about to be rolled around the roll core 4, and thus the edge portion of the glass film 2 inappropriately bends the subsequent part of the glass film 2. As a result, there is a problem in that, at the position indicated by the arrow X, high bending stress acts on the glass film 2 so that the glass film 2 breaks.

Further, there is the following problem. Specifically, even if the edge portion of the glass film 2 does not break at the time of rolling, when impact is applied to the glass film later during transportation or the like, stress is concentrated on a region which is pushed up by the edge portion of the glass film 2 separating from the periphery of the roll core 4 and thus is subjected to action of bending stress, with the result that the glass film breaks.

In view of the above-mentioned circumstances, it is a technical object of the present invention to suppress as much as possible a situation in which the edge portion of the glass film on the rolling start side separates from the periphery of the roll core, and to realize a stable packaging state which is less likely to cause breakage of the glass film.

### Solution to Problems

According to an exemplary embodiment of the present invention that has been made in order to solve the above-mentioned problems, there is provided a glass roll, comprising: a glass film; a protective film; and a roll core, around which the glass film is rolled into a roll under a state in which the protective film is superposed on the glass film, wherein: the protective film is superposed on an outer peripheral surface side of the glass film under a state in which tension of from 100 kPa to 1 GPa is applied to the protective film in a rolling direction; and the following relationships hold true:

{(tg×Eg)/(tp×Ep)}×(tg/R)≦0.1; and

tg/R≦1×10⁻³,

where tg [m] represents a thickness of the glass film, Eg [Pa] represents a tensile modulus of elasticity of the glass film, tp [m] represents a thickness of the protective film, Ep [Pa] represents a tensile modulus of elasticity of the protective film, and R [m] represents an outer diameter of the roll core. Note that, in the following description, in some cases, a value of {(tg×Eg)/(tp×Ep)}×(tg/R) is referred tows a “rollability index”, and a value of tg/R is referred to as a “rolling breakage index”.

That is, as a value of tg×Eg [m·Pa] is increased, a restoring force of the glass film is increased, thereby increasing a force exerted by the glass film to separate from the periphery of the roll core. Further, as the value of tg/R is increased, the thickness of the glass film becomes larger relative to a rolling diameter, thereby increasing the force exerted by the glass film to separate from the periphery of the roll core. On the other hand, as a value of tp×Ep [m·Pa] is increased, a force to press the glass film toward the roll core is increased when tension acts on the protective film. In other words, the protective film increases a force to prevent the glass film from separating (flipping) from the roll core.

Therefore, as a result of diligent researches with a focus on the above-mentioned points, the inventors of the present invention found out the following. Specifically, under a state in which the tension acting on the protective film is controlled properly, when the glass roll satisfies the relationships tg/R≦1×10⁻³ and {(tg×Eg)/(tp×Ep)}×(tg/R)≦0.1, a force exerted by the resin film to prevent the glass film from separating acts effectively against a force exerted by the glass film itself to separate from the roll core, with the result that it is possible to reliably prevent a situation in which the edge portion of the glass film on the rolling start side separates from the periphery of the roll core.

Here, the reason why the value of tg/R is limited to the above-mentioned numerical range is as follows. That is, when the value of tg/R exceeds 1×10⁻³, the outer diameter of the roll core is too small with respect to the thickness of the glass film. Accordingly, when the glass film is rolled along the periphery of the roll core, inappropriately high stress acts on the glass film, with the result that the glass film may break.

Further, the reason why the tension acting on the protective film is limited to the above-mentioned numerical range is as follows. That is, when the tension applied to the protective film is lower than 100 kPa, the tension acting on the protective film is too weak, and hence it is difficult for the protective film to press the glass film toward the roll core. On the other hand, when the tension applied to the protective film exceeds 1 GPa, the protective film may break. Accordingly, in order to avoid those problems, the tension applied to the protective film is limited to the above-mentioned numerical range. Further, when the tension is within this range, the glass film and the protective film can be rolled around the roll core under a state in which the glass film and the protective film are held in close contact with each other with no gap. Note that, it is preferred that the tension applied to the protective film be within a range of from 15 MPa to 40 MPa.

In the above-mentioned configuration, it is preferred that a value of tg/R be equal to or larger than 1×10⁻⁵ (1×10⁻⁵ to 1×10⁻³).

That is, when the value of tg/R is smaller than 1×10⁻⁵, the outer diameter of the roll core is large relative to the thickness of the glass film. Accordingly, when the glass film is rolled along the periphery of the roll core, stress (bending stress) acting on the glass film is reduced. Therefore, a situation in which the glass film breaks is less likely to occur, but a size of the roll core is inappropriately increased, which leads to a reduction in transportation efficiency. Accordingly, in order to avoid this problem, it is preferred that the value of tg/R be within the above-mentioned numerical range.

In the above-mentioned configuration, it is preferred that a value of tg×Eg range from 5.0×10⁵ to 5.0×10⁷ [m·Pa], and a value of tp×Ep range from 1.0×10⁴ to 1.0×10⁷ [m·Pa].

With this, the ranges of tg×Eg and tp×Ep are further optimized, and hence the protective film can press the glass film toward the roll core more reliably.

In this case, it is more preferred that the value of tg×Eg range from 5.0×10⁶ to 5.0×10⁷ [m·Pa], the value of tp×Ep range from 1.0×10⁵ to 1.0×10⁷ [m·Pa], and the value of tg/R range from 5×10⁻⁵ to 8.0×10⁻⁴.

That is, the relationship among tg×Eg, tp×Ep, and tg/R is kept more satisfactorily, and hence the protective film can more advantageously exert an effect of pressing the glass film.

According to an exemplary embodiment of the present invention that has been made in order to solve the above-mentioned problems, there is provided a manufacturing method for a manufacturing method for a glass roll, the manufacturing method comprising rolling a glass film into a roll around a roll core under a state in which a glass film is superposed on the protective film, wherein: the protective film is superposed on an outer peripheral surface side of the glass film under a state in which tension of from 100 kPa to 1 GPa is applied to the protective film in a rolling direction; and the rolling comprises rolling the glass film on which the protective film is superposed so that the following relationships hold true:

{(tg×Eg)/(tp×Ep)}×(tg/R)≦0.1; and

tg/R≦1×10⁻³,

where tg [m] represents a thickness of the glass film, Eg [Pa] represents a tensile modulus of elasticity of the glass film, tp [m] represents a thickness of the protective film, Ep [Pa] represents a tensile modulus of elasticity of the protective film, and R [m] represents an outer diameter of the roll core.

With this method, it is possible to produce the same functions and effects as those described above.

In the above-mentioned method, it is preferred that a value of tg/R be equal to or larger than 1×10⁻⁵.

### Advantageous Effects of Invention

According to the present invention described above, the protective film, which is superposed on the outer peripheral surface side of the glass film, can suppress as much as possible a situation in which the edge portion of the glass film on the rolling start side separates from the periphery of the roll core, and can realize a stable packaging state which is less likely to cause breakage of the glass film.

### BRIEF DESCRIPTION OF DRAWINGS

FIG. 1 A diagram illustrating a glass roll according to an embodiment of the present invention.

FIG. 2 A diagram illustrating a manufacturing method for a glass roll according to the embodiment of the present invention.

FIG. 3 A diagram illustrating another manufacturing method for a glass roll according to the embodiment of the present invention.

FIG. 4A A diagram illustrating a problem of a conventional glass roll.

FIG. 4B A diagram illustrating a problem of the conventional glass roll.

### DESCRIPTION OF EMBODIMENT

Hereinafter, an embodiment of the present invention is described with reference to the drawings.

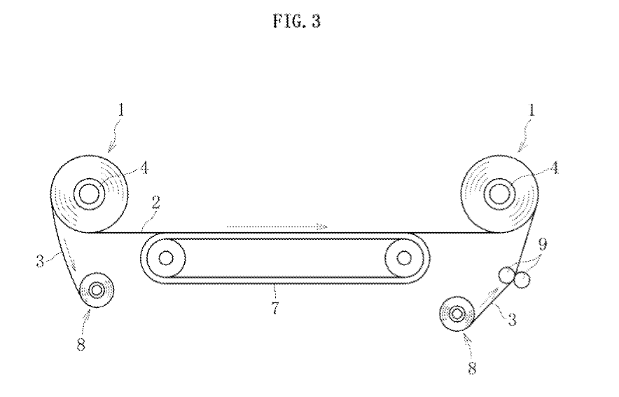

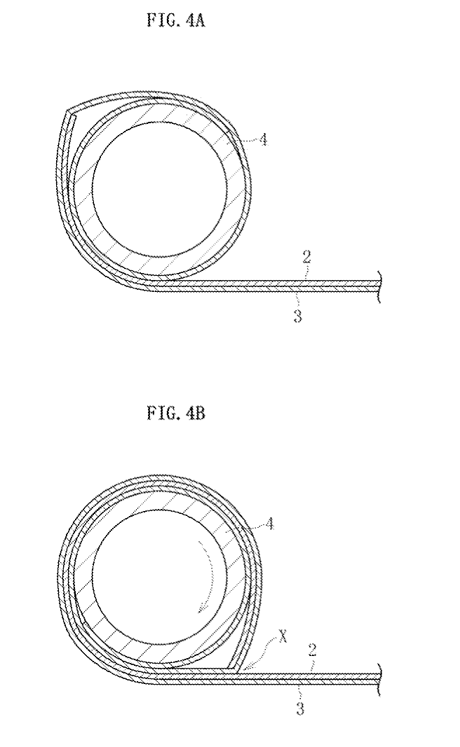

FIG. 1 is a perspective view illustrating a glass roll according to the embodiment of the present invention. A glass roll 1 is formed by rolling a glass film 2 and a resin film 3 together around a roll core 4 under a state in which the resin film 3 as a protective film is superposed on an outer peripheral surface side of the glass film 2. Note that, the resin film 3 is rolled around an outer peripheral surface of the roll core 4 in advance, and thus prevents the glass film 2 rolled around the roll core 4 from coming into direct contact with the outer peripheral surface of the roll core 4 (for example, see FIGS. 3, 4A, and 4B).

The glass film 2 is formed by an overflow downdraw method into a long film having a thickness of from 1 μm to 600 μm (preferably, 1 μm to 300 μm, and more preferably, 10 μm to 200 μm). The glass film 2 is employed for, for example, a flat panel display (FPD) such as a liquid crystal display, a plasma display, and an OLED display, a glass substrate for a device such as a solar cell, a lithium ion battery, a digital signage, a touch panel, and an electronic paper display, a cover glass for an OLED lighting, a glass container for medical supplies, a window glass, and a lightweight laminated window glass. The reason why the glass film is set to have such a thickness is because, with the thickness within the above-mentioned numerical range, appropriate flexibility and strength can be imparted to the glass film 2 and no trouble arises at the time of rolling. In other words, when the thickness of the glass film 2 is less than 1 μm, handling of the glass film is troublesome because of lack of strength. When the thickness of the glass film 2 exceeds 600 μm, satisfactory flexibility is not obtained, which leads to a problem in that a rolling radius is inappropriately and inevitably increased.

A width of the glass film 2 is preferably 100 mm or more, more preferably 300 mm or more, and still more preferably 500 mm or more. Note that, the glass film 2 is used for a wide variety of devices including a small-screen display such as a mobile phone with a small size and a large-screen display such as a television set with a large size. Thus it is preferred that the width of the glass film 2 be finally selected as needed depending on a size of a substrate of a device to be used.

As a glass composition of the glass film 2, there can be used various glass compositions of silicate glass and the like, such as silica glass and borosilicate glass. However, it is preferred to use non-alkali glass. The reason is as follows. When the glass film 2 contains an alkali component, a so-called too-abundant soda phenomenon occurs so that the glass film is structurally weathered. When the glass film 2 is curved, there is a risk in that the glass film is prone to break from a portion that is structurally weathered over time. Note that, herein, the non-alkali glass comprises glass that does not substantially contain an alkali component, specifically, glass containing an alkali metal oxide of 1,000 ppm or less (preferably, of 500 ppm or less, and more preferably, of 300 ppm or less).

Further, in view of ensuring strength of the glass film 2, it is preferred that at least each widthwise end surface of the glass film 2 comprise a cut surface which is cut by laser cutting such as laser cleaving and laser fusing. With this configuration, the each widthwise end surface of the glass film 2 has a cross-section with high strength free from defects causing breakage, such as micro cracks. Specifically, when utilizing the laser cleaving, without being subjected to polishing or the like after the cutting, the each widthwise end surface of the glass film 2 is allowed to have an arithmetic average roughness Ra (compliant to JIS B0601:2001) of 0.1 μm or less (preferably, 0.05 μm or less). Here, the laser cleaving refers to a method of cutting the glass film 2 in such a manner that an initial crack is caused to develop by utilizing thermal stress that is generated through expansion due to a heating action of a laser and through contraction due to a cooling action of a refrigerant. On the other hand, the laser fusing is a cutting method of jetting high pressure gas to a region of glass that is heated by laser energy to be softened and melted. An end surface of the glass is temporarily melted, and hence is formed to be smooth and to have a substantially circular-arc shape in cross-section. Accordingly, even when the end surface of the glass comes into contact with an object, micro cracks are less likely to occur in the end surface.

It is preferred that the resin film 3 have a thickness of from 20 μm to 1,000 μm (more preferably, 25 μm to 500 μm). Further, it is preferred that a width of the resin film 3 be larger than a width of the glass film 2 in order to protect both widthwise end surfaces of the glass film 2 from various contacts. As a matter of course, the thickness and the width of the resin film 3 are not limited thereto.

As the resin film 3, there can be used, for example, an ionomer film, a polyethylene film, a polypropylene film, a polyvinyl chloride film, a polyvinylidene chloride film, a polyvinyl alcohol film, a polyester film, a polycarbonate film, a polystyrene film, a polyacrylonitrile film, an ethylene vinyl acetate copolymer film, an ethylene-vinyl alcohol copolymer film, an ethylene-methacrylate copolymer film, a nylon (trademark) film (polyamide film), a polyimide film, and an organic resin film (synthetic resin film) such as cellophane. In addition, in view of ensuring cushioning performance, as the resin film 3, a foamed resin film such as a polyethylene foamed resin may be used.

Further, the glass roll 1 having the above-mentioned configuration satisfies the following two conditions as a constituent feature.

Firstly, the glass roll 1 satisfies the condition that tension of from 100 kPa to 1 GPa is applied to the resin film 3 in a rolling direction (longitudinal direction) at the time of rolling.

In this way, under a state in which the glass film 2 and the resin film 3 are held in close contact with each other with no gap, the glass film 2 and the resin film 3 can be rolled around the roll core, and hence the glass film 2 rolled around the roll core 4 is less likely to loosen. Note that, it is preferred that the tension applied to the resin film 3 be within a range of from 15 MPa to 40 MPa.

Further, secondly, the glass roll 1 satisfies the condition that, the following relationships hold true:

{(tg×Eg)/(tp×Ep)}×(tg/R)≦0.1 (1); and

1×10⁻⁵≦(tg/R)≦1×10⁻³ (2),

where tg [m] represents a thickness of the glass film 2, Eg [Pa] represents a tensile modulus of elasticity of the glass film 2, tp [m] represents a thickness of the resin film 3, Ep [Pa] represents a tensile modulus of elasticity of the resin film 3, and R [m] represents an outer diameter of the roll core.

That is, in the left side of Expression (1) expressing a rollability index, tg×Eg and tg/R (rolling breakage index) represent a force exerted by the glass film 2 itself to separate from a periphery of the roll core 4, and tp×Ep represents a force which is exerted by the resin film 3 to prevent the glass film 2 from separating from the roll core 4. Then, when those relationships satisfy Expression (1), the force exerted by the resin film 3 to prevent the glass film 2 from separating acts effectively on the force exerted by the glass film 2 itself to separate from the roll core 4. Thus, it is possible to reliably prevent an edge portion of the glass film 2 on a rolling start side from separating.

Here, the reason why such a relational expression as Expression (2) is defined is as follows. That is, when the value of tg/R exceeds 1×10⁻³, the outer diameter R of the roll core 4 is too small with respect to the thickness tg of the glass film 2. Accordingly, when the glass film 2 is rolled along the periphery of the roll core 4, stress acting on the glass film 2 is inappropriately increased, with the result that the glass film 2 may break. On the other hand, when the value of tg/R is smaller than 1×10⁻⁵, a situation in which the glass film 2 breaks due to the above-mentioned stress is less likely to occur, but a size of the roll core 4 is inappropriately increased, which leads to degraded transportation efficiency. Accordingly, in order to avoid those problems, the range of tg/R is limited to the above-mentioned numerical range.

Note that, it is preferred that the value of tg×Eg range from 5.0×10⁵ to 5.0×10⁷ [m·Pa] and the value of tp×Ep range from 1.0×10⁴ to 1.0×10⁷ [m·Pa], and more preferred that the value of tg×Eg range from 5.0×10⁶ to 5.0×10⁷ [m·Pa], the value of tp×Ep range from 1.0×10⁵ to 1.0×10⁷ [m·Pa], and the value of tg/R range from 5×10⁻⁵ to 8.0×10⁻⁴.

Next, description is made of a manufacturing method for the glass roll configured as described above.

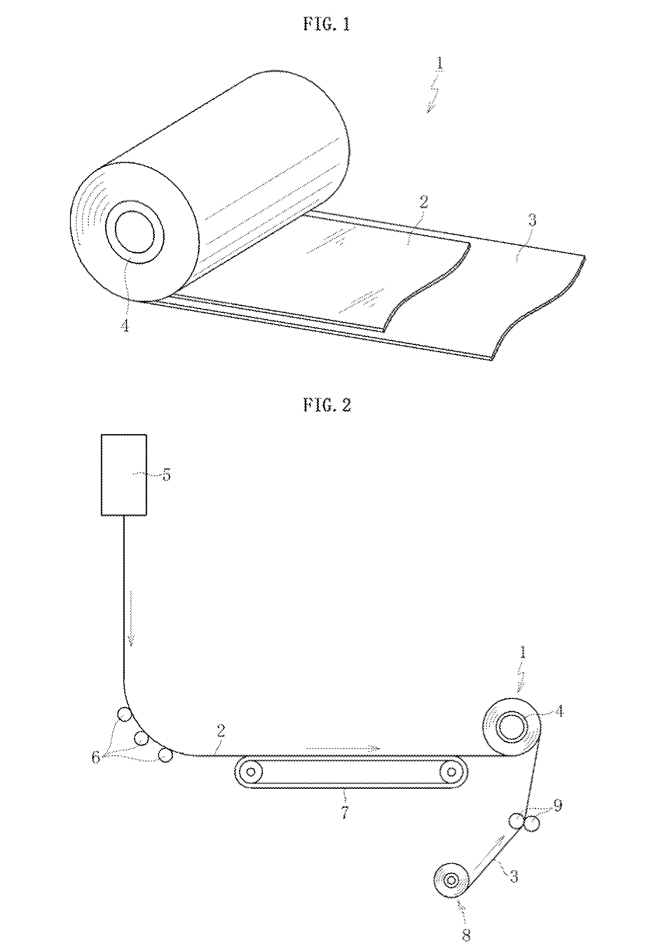

First, as illustrated in FIG. 2, the glass film 2 is manufactured by a forming device 5 for carrying out a downdraw method such as an overflow downdraw method, a slot downdraw method, and a redraw method. Next, under a state in which the manufactured glass film 2 is guided downward from the forming device 5, the manufactured glass film 2 is curved in a substantially horizontal direction by a roller group 6 or the like midway through a conveying path thereof. Then, under a state in which the posture of the glass film 2 is kept curved in the substantially horizontal direction, the glass film 2 is conveyed to a downstream side of the conveying path by a conveying device 7 such as a belt conveyor. Finally, at a downstream end of the conveying path, the glass film 2 being conveyed by the conveying device 7 is rolled around the roll core 4 continuously.

At this time, the resin film 3 pulled out of a resin roll 8 is superposed on the outer peripheral surface side of the glass film 2, and then rolled around the roll core 4 together with the glass film 2. Then, nip rollers 9 or the like apply tension of from 100 kPa to 1 GPa to the resin film 3 in the rolling direction.

Further, the thickness (tg) and the modulus of elasticity (Eg) of the glass film 2, the thickness (tp) and the modulus of elasticity (Ep) of the resin film 3, and the outer diameter (R) of the roll core 4 are set in advance so as to satisfy Expressions (1) and (2). Specifically, properties (including a thickness and a modulus of elasticity) demanded for the glass film 2 to be manufactured are determined in advance. Accordingly, depending on those properties demanded for the glass film 2, the thickness and the modulus of elasticity of the resin film 3 and the outer diameter of the roll core 4 are adjusted so as to set rolling conditions satisfying Expressions (1) and (2).

Note that, as illustrated in FIG. 3, the glass roll 1 satisfying the above-mentioned conditions may be manufactured in a manner that a roll-to-roll apparatus is used to roll again the glass roll 1 formed by rolling the glass film 2. Note that, also in this case, depending on the thickness and the modulus of elasticity of the glass film 2, the thickness and the modulus of elasticity of the resin film 3 and the outer diameter of the roll core 4 are adjusted so as to set rolling conditions satisfying Expressions (1) and (2).

### Examples

Examples of the present invention are described.

As glass employed for a material of a glass film, a glass material OA-10G (having a tensile modulus of elasticity of 73 GPa) manufactured by Nippon Electric Glass Co., Ltd. was used. Further, as the glass film, a film obtained by the following manner was used. Specifically, the film was formed by an overflow downdraw method from the glass material so as to have a predetermined thickness, and subjected to laser cleaving (full-body cleaving) so as to have a width of 800 mm and a length of 15 m.

As a resin film, the following film was used. Specifically, the film was formed of a polyethylene terephthalate (PET) film having a predetermined tensile modulus of elasticity and a predetermined thickness, and cut into a strip having a width of 900 mm and a length of 20 m.

As a roll core, a vinyl chloride tube having a predetermined outer diameter, a thickness of 10 mm, and an axial length of 1,000 mm was used.

A glass roll was fabricated in the following manner. First, under a state in which tension of 20 MPa was applied to the resin film along a rolling direction, the resin film was rolled around the roll core by an amount corresponding to five cycles or a length of 5 m. Next, the glass film was inserted between a part of the resin film that was about to be rolled, and a part of the resin film that was already rolled around the roll core, and then the glass film was rolled sequentially under a state in which the glass film was wrapped in between the parts of the resin film.

Further, when fabricating the glass roll in this manner, it was examined whether or not breakage occurred in an edge portion of the glass film on a rolling start side, and in a contact portion of the glass film with which the edge portion came into contact. The results are shown in Table 1. Note that, in the column of Table 1 showing rollability, a mark “oo” represents the result that the glass roll can be manufactured in a remarkably stable state, a mark “o” represents the result that the glass roll can be manufactured in a stable state though inferior to the state represented by the mark “oo”, a mark “Δ” represents the result that the glass roll can be manufactured in a practically acceptable state despite a risk of some trouble, and a mark “x” represents the result that breakage occurs in the glass film in a process of manufacturing the glass roll.

TABLE 1

| | Glass film | | Resin film | | | | | | | |
|---|---|---|---|---|---|---|---|---|---|---|
| | | Tensile | | Tensile | Outer | Rolling | | | | |
| | Thick- | modulus of | | modulus of | diameter | breakage | tg · Eg | tp · Ep | | |
| | ness | elasticity | Thickness | elasticity | of roll | index [—] × | [m · Pa] × | [m · Pa] × | Rollability | |
| | [μm] | [GPa] | [μm] | [GPa] | core [mm] | 10⁻³ | 10⁶ | 10³ | index [—] | Rollability |
| Example 1 | 50 | 73 | 50 | 3.4 | 250 | 0.20 | 3.65 | 170 | 0.004 | ∘ |
| Example 2 | 200 | 73 | 20 | 3.4 | 500 | 0.40 | 14.60 | 68 | 0.086 | ∘ |
| Example 3 | 200 | 73 | 188 | 3.3 | 250 | 0.80 | 14.60 | 620 | 0.019 | ∘∘ |
| Example 4 | 250 | 73 | 50 | 3.4 | 500 | 0.50 | 18.25 | 170 | 0.054 | ∘∘ |
| Example 5 | 250 | 73 | 188 | 3.3 | 400 | 0.63 | 18.25 | 620 | 0.018 | ∘∘ |
| Example 6 | 300 | 73 | 50 | 3.4 | 400 | 0.75 | 21.90 | 170 | 0.097 | ∘∘ |
| Example 7 | 300 | 73 | 100 | 1 | 1,000 | 0.30 | 21.90 | 100 | 0.066 | ∘ |
| Example 8 | 10 | 50 | 50 | 3.4 | 12.5 | 0.80 | 0.50 | 170 | 0.002 | ∘ |
| Example 9 | 50 | 73 | 100 | 0.1 | 500 | 0.10 | 3.65 | 10 | 0.037 | ∘ |
| Example 10 | 20 | 73 | 100 | 0.1 | 2,000 | 0.01 | 1.46 | 10 | 0.001 | ∘ |
| Example 11 | 500 | 100 | 188 | 3.3 | 800 | 0.63 | 50.00 | 620 | 0.050 | ∘∘ |
| Example 12 | 300 | 73 | 1,000 | 10 | 600 | 0.50 | 21.90 | 10,000 | 0.001 | ∘∘ |
| Example 13 | 70 | 73 | 50 | 3.4 | 250 | 0.28 | 5.11 | 170 | 0.008 | ∘∘ |
| Example 14 | 50 | 73 | 50 | 3.4 | 1,000 | 0.05 | 3.65 | 170 | 0.001 | ∘ |
| Example 15 | 50 | 73 | 50 | 3.4 | 50 | 1.00 | 3.65 | 170 | 0.021 | Δ |
| Example 16 | 50 | 73 | 90 | 0.1 | 500 | 0.10 | 3.65 | 9 | 0.041 | Δ |
| Example 17 | 8 | 50 | 100 | 1 | 20 | 0.40 | 0.40 | 100 | 0.002 | Δ |
| Example 18 | 300 | 73 | 1,000 | 10.1 | 600 | 0.50 | 21.90 | 10,100 | 0.001 | Δ |
| Example 19 | 550 | 100 | 188 | 3.3 | 800 | 0.69 | 55.00 | 620 | 0.061 | Δ |
| Example 20 | 25 | 73 | 100 | 0.1 | 3,000 | 0.008 | 1.83 | 10 | 0.002 | ∘ |
| Comparative | 50 | 73 | 25 | 1 | 70 | 0.71 | 3.65 | 25 | 0.104 | x |
| Example 1 | | | | | | | | | | |
| Comparative | 50 | 73 | 50 | 3.4 | 45 | 1.11 | 3.65 | 170 | 0.024 | x |
| Example 2 | | | | | | | | | | |
| Comparative | 50 | 73 | 100 | 0.1 | 150 | 0.33 | 3.65 | 10 | 0.122 | x |
| Example 3 | | | | | | | | | | |
| Comparative | 50 | 73 | 100 | 1 | 45 | 1.11 | 3.65 | 100 | 0.041 | x |
| Example 4 | | | | | | | | | | |
| Comparative | 250 | 73 | 50 | 3.4 | 250 | 1.00 | 18.25 | 170 | 0.107 | x |
| Example 5 | | | | | | | | | | |

As shown in the results, as in Comparative Example 1, Comparative Example 3, and Comparative Example 5, when the rollability index exceeds 0.1, an elastic restoring force of the glass film is increased, and hence the glass film breaks at a part (such as the edge portion on the rolling start side) at which the glass film separates from the roll core and the glass film is wrapped in.

Further, as in Comparative Example 2 and Comparative Example 4, even when the rollability index is equal to or smaller than 0.1, when the rolling breakage index exceeds 1×10⁻³, the outer diameter of the roll core is too small with respect to the thickness of the glass film. Accordingly, when the glass film is rolled along the periphery of the roll core, high stress (bending stress) acts on the glass film, with the result that the glass film may break easily.

In contrast, in Example 1 to Example 20, the rollability index is equal to or smaller than 0.1, and the rolling breakage index is equal to or smaller than 1×10⁻³. In Example 1 to Example 20 satisfying those conditions, the results that the glass roll can be manufactured without breakage of the glass film were obtained.

Here, as in Example 20, when the rolling breakage index is smaller than 1×10⁻⁵, the outer diameter of the roll core is large relative to the thickness of the glass film. This reduces the stress (bending stress) acting on the glass film when the glass film is rolled along the periphery of the roll core, and reduces a risk in that the glass film breaks. However, in this case, a size of the roll core is inappropriately increased, which may cause a problem in that productivity is deteriorated or transportation efficiency is degraded. Therefore, as in Example 1 to Example 19, it is preferred that the rolling breakage index range from 1×10⁻⁵ to 1×10⁻³.

Further, as in Example 17, when the value of tg×Eg is smaller than 5.0×10⁵ [m·Pa], the glass roll can be manufactured, but in some cases, there arises a phenomenon that wrinkles are formed in the glass film. In this case, when the tension is applied to the resin film and thus the resin film is held in close contact with the glass film, unnecessary stress acts on the glass film, which leads to a difficulty in handling the glass roll because, for example, breakage may occur during transportation. Further, as in Example 19, when the value of tg×Eg exceeds 5.0×10⁷ [m·Pa], a rolling diameter tends to be increased. Similarly, as in Example 16, when the value of tp×Ep is smaller than 1.0×10⁴ [m·Pa], the resin film is too soft, and hence there is a fear in that it is difficult to reliably roll, along the periphery of the roll core, the glass film exhibiting the value of tg×Eg ranging from 5.0×10⁵ to 5.0×10⁷ [m·Pa]. On the other hand, as in Example 18, when the value of tp×Ep exceeds 1.0×10⁷ [m·Pa], the resin film is too hard, and hence it is necessary to apply higher tension than necessary when the resin film is rolled around the roll core under a state in which the resin film is superposed on the glass film, which may cause deteriorated workability. Therefore, it is preferred that, in the glass roll, the value of tg×Eg range from 5.0×10⁵ to 5.0×10⁷ [m·Pa] and the value of tp×Ep range from 1.0×10⁴ to 1.0×10⁷ [m·Pa]. This can be confirmed because the state of the glass roll is satisfactory in each of Example 1 to Example 15 that satisfies those ranges. Further, from the results of Examples 3 to 6 and Examples 11 to 13 each showing the most satisfactory state of the glass roll, it can be recognized that it is most preferred that the value of tg×Eg range from 5.0×10⁶ to 5.0×10⁷ [m·Pa], the value of tp×Ep range from 1.0×10⁵ to 1.0×10⁷ [m·Pa], and the rolling breakage index range from 5×10⁻⁵ to 8.0×10⁻⁴.

### REFERENCE SIGNS LIST

1 glass roll
2 glass film
3 resin film
4 roll core
5 forming device
6 roller group
7 conveying device
8 resin roll
9 nip roller

1. A glass roll, comprising:
a glass film;
a protective film; and
a roll core, around which the glass film is rolled into a roll under a state in which the protective film is superposed on the glass film, wherein:
the protective film is superposed on an outer peripheral surface side of the glass film under a state in which tension of from 100 kPa to 1 GPa is applied to the protective film in a rolling direction; and
the following relationships hold true:
{(tg×Eg)/(tp×Ep)}×(tg/R)≦0.1; and
tg/R≦1×10⁻³,
where tg [m] represents a thickness of the glass film, Eg [Pa] represents a tensile modulus of elasticity of the glass film, tp [m] represents a thickness of the protective film, Ep [Pa] represents a tensile modulus of elasticity of the protective film, and R [m] represents an outer diameter of the roll core.

2. The glass roll according to claim 1, wherein a value of tg/R is equal to or larger than 1×10⁻⁵.

3. The glass roll according to claim 1, wherein:
a value of tg×Eg ranges from 5.0×10⁵ to 5.0×10⁷ [m·Pa]; and
a value of tp×Ep ranges from 1.0×10⁴ to 1.0×10⁷ [m·Pa].

4. The glass roll according to claim 1, wherein:
a value of tg×Eg ranges from 5.0×10⁶ to 5.0×10⁷ [m·Pa];
a value of tp×Ep ranges from 1.0×10⁵ to 1.0×10⁷ [m·Pa]; and
the value of tg/R ranges from 5×10⁻⁵ to 8.0×10⁻⁴.

5. A manufacturing method for a glass roll, the manufacturing method comprising rolling a glass film into a roll around a roll core under a state in which a protective film is superposed on the glass film, wherein:
the protective film is superposed on an outer peripheral surface side of the glass film under a state in which tension of from 100 kPa to 1 GPa is applied to the protective film in a rolling direction; and
the rolling comprises rolling the glass film on which the protective film is superposed so that the following relationships hold true:
{(tg×Eg)/(tp×Ep)}×(tg/R)≦0.1; and
tg/R≦1×10⁻³,
where tg [m] represents a thickness of the glass film, Eg [Pa] represents a tensile modulus of elasticity of the glass film, tp [m] represents a thickness of the protective film, Ep [Pa] represents a tensile modulus of elasticity of the protective film, and R [m] represents an outer diameter of the roll core.

6. The manufacturing method for a glass roll according to claim 5, wherein a value of tg/R is equal to or larger than 1×10⁻⁵.

7. The glass roll according to claim 2, wherein:
a value of tg×Eg ranges from 5.0×10⁵ to 5.0×10⁷ [m·Pa]; and
a value of tp×Ep ranges from 1.0×10⁴ to 1.0×10⁷ [m·Pa].

8. The glass roll according to claim 2, wherein:
a value of tg×Eg ranges from 5.0×10⁶ to 5.0×10⁷ [m·Pa];
a value of tp×Ep ranges from 1.0×10⁵ to 1.0×10⁷ [m·Pa]; and
the value of tg/R ranges from 5×10⁻⁵ to 8.0×10⁻⁴.
